(19) United States
(12) Patent Application Publication
(10) Pub. No.: US 2018/0326816 A1
(43) Pub. Date: Nov. 15, 2018

(54) HEATING DEVICE

(71) Applicant: CALSONIC KANSEI CORPORATION, Saitama-shi, Saitama (JP)

(72) Inventor: Takashi OTSUKA, Saitama-shi, Saitama (JP)

(73) Assignee: CALSONIC KANSEI CORPORATION, Saitama-shi, Saitama (JP)

(21) Appl. No.: 15/755,907

(22) PCT Filed: Aug. 9, 2016
(86) PCT No.: PCT/JP2016/073505

§ 371 Date: Feb. 27, 2018

(30) Foreign Application Priority Data
Sep. 2, 2015 (JP) 2015-172917
Jul. 5, 2016 (JP) 2016-133200

(51) Int. Cl. B60H 1/22; H05B 1/02; B60H 1/00

(52) U.S. Cl. CPC B60H 1/2218; H05B 1/0202; B60H 2001/2231; B60H 2001/224; B60H 1/00385

(57) ABSTRACT

A heating device includes: a heater that generates heat when electrical power is supplied; and at least two switching elements connected to the heater in series, the switching elements being configured to switch supply and interruption of electrical power to the heater by being switched on and off, wherein a first switching element of the at least two switching elements is kept at on state while switching operation of a second switching element is repeated between on and off.

### TECHNICAL FIELD

The present invention relates to a heating device.

### BACKGROUND ART

JP2013-082377A discloses a control unit of a vehicle-mounted heater for heating a vehicle cabin. In JP2013-082377A, a pair of IGBTs (Insulated Gate Bipolar Transistors) are provided in series with respect to the heater, and the IGBTs are forcedly switched off when the temperatures of the IGBT is equal to or greater than a predetermined temperature.

### SUMMARY OF INVENTION

With the IGBTs used for the switching operation of the heater described above, there is a risk in that an abnormality may be caused during the operation of switching on and off due to, for example, a surge voltage.

An object of the present invention is to prevent abnormalities from being caused in a plurality of switching elements simultaneously.

According to one aspect of the present invention, a heating device includes: a heater configured to generate heat when electrical power is supplied; and at least two switching elements connected to the heater in series, the switching elements being configured to switch supply and interruption of electrical power for the heater by being switched on and off, wherein a first switching element of the at least two switching elements is kept at on state while switching operation of a second switching element is repeated between on and off.

According to this aspect, the first switching element of at least two switching elements is kept at on state when the second switching element is repeatedly switched on and off. Therefore, because the second switching element is switched off at the time when the first switching element is switched on, the electrical power is not supplied to the heater. By doing so, the current does not flow even if the first switching element is switched on, and so, the first switching element is prevented from becoming an abnormal state. Therefore, it is possible to prevent abnormalities from being caused in a plurality of switching elements simultaneously.

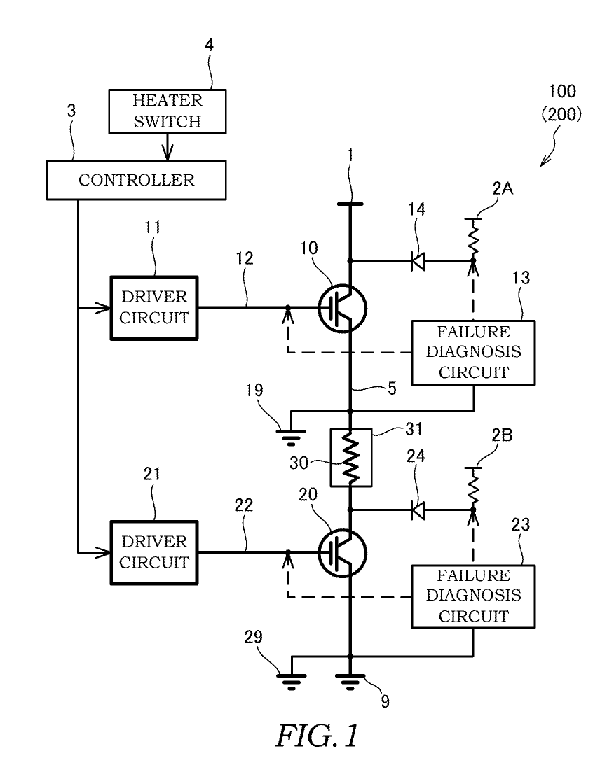

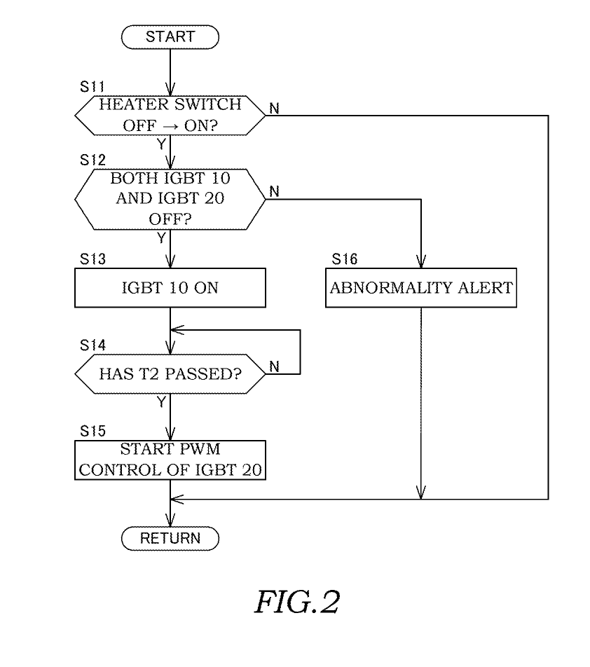

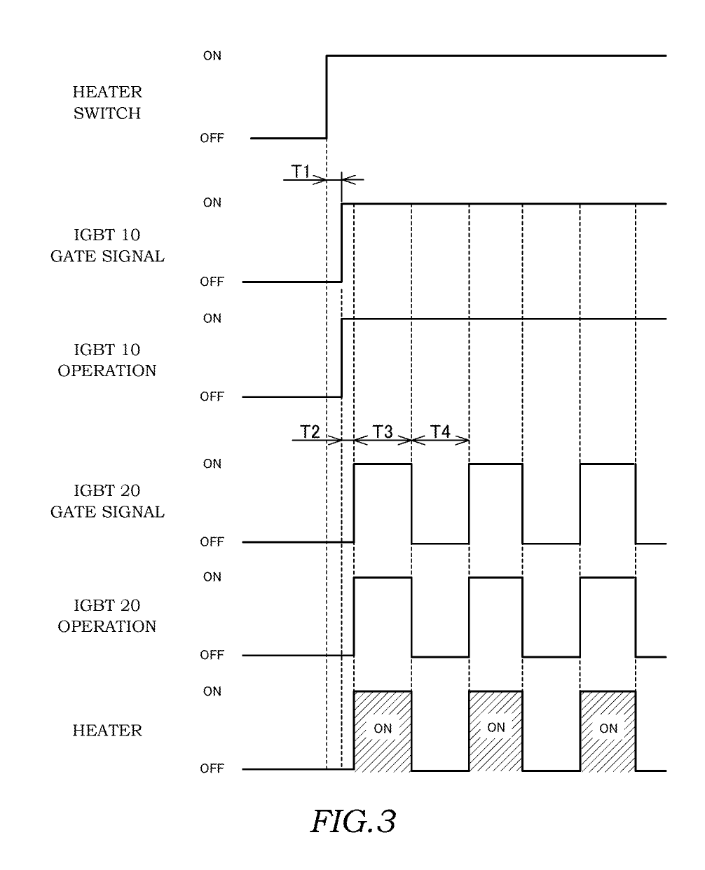

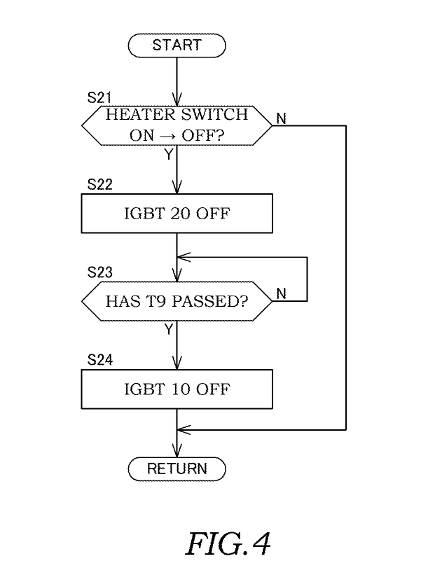

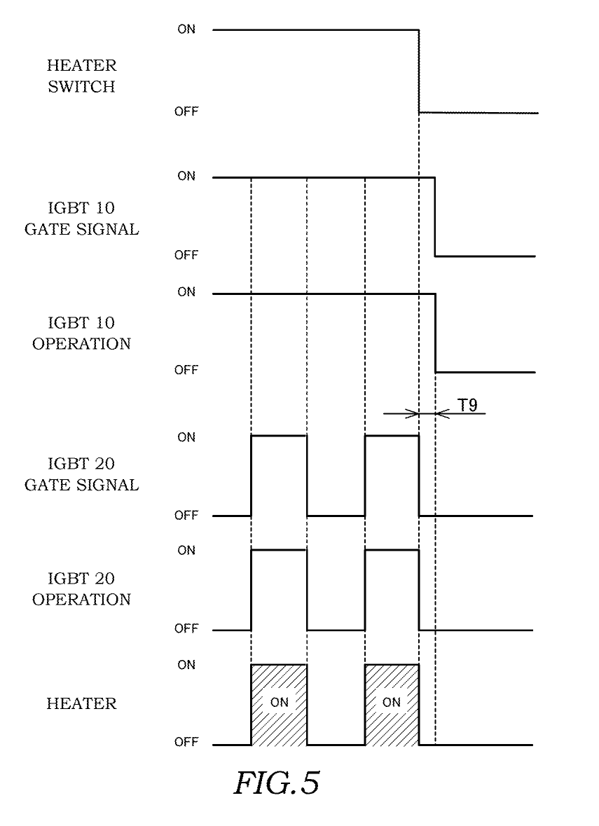

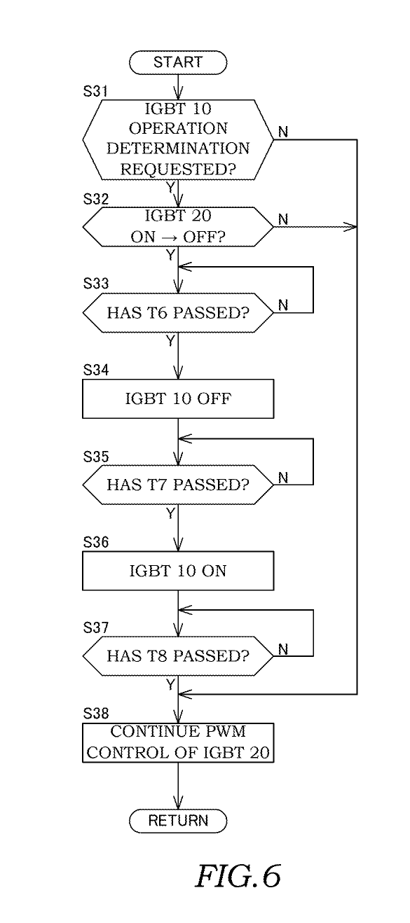

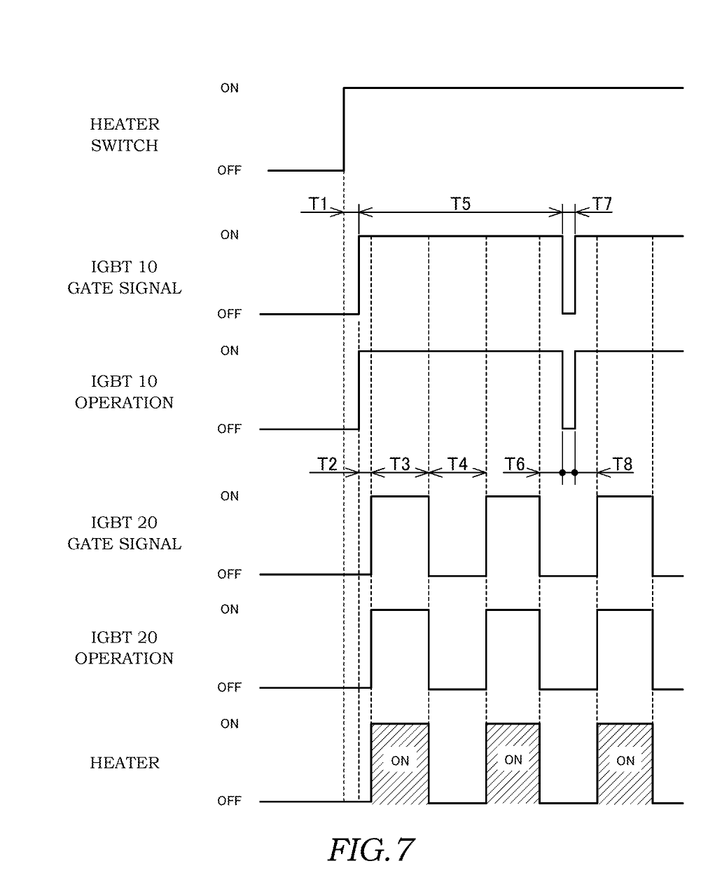

### BRIEF DESCRIPTION OF DRAWINGS

[FIG. 1] FIG. 1 is a configuration diagram of a heating device according to first and second embodiments of the present invention.

[FIG. 2] FIG. 2 is a flowchart explaining an operation of the heating device according to the first embodiment of the present invention when a heater switch is switched on.

[FIG. 3] FIG. 3 is a time chart explaining the operation of the heating device when the heater switch is switched on.

[FIG. 4] FIG. 4 is a flowchart explaining the operation of the heating device when the heater switch is switched off.

[FIG. 5] FIG. 5 is a time chart explaining the operation of the heating device when the heater switch is switched off.

[FIG. 6] FIG. 6 is a flowchart explaining the operation of the heating device according to the second embodiment of the present invention.

[FIG. 7] FIG. 7 is a time chart explaining the operation of the heating device.

### DESCRIPTION OF EMBODIMENTS

Embodiments of the present invention will be described below with reference to the drawings.

### First Embodiment

A heating device 100 according to the first embodiment of the present invention will be described below with reference to FIGS. 1 to 5.

An overall configuration of the heating device 100 will be described first with reference to FIG. 1.

The heating device 100 includes a heater 30 that is driven by electrical power supplied from a DC power source 1 and IGBTs (Insulated Gate Bipolar Transistor) 10 and 20 serving as switching elements connected to the heater 30 in series. Here, although a description is given of a case in which a pair of IGBTs are provided, the number of IGBTs is not limited to a pair, and it suffices to provide at least two IGBTs.

The heating device 100 is applied to a vehicle air-conditioning device (not shown) mounted on a vehicle such as an EV (Electric Vehicles), an HEV (Hybrid Electric Vehicles), and so forth. In order to perform cabin-heating operation, the vehicle air-conditioning device has a hot water tank 31 for heating cooling medium with the heater 30.

The DC power source 1 is a high voltage battery mounted on EV, HEV, and so forth. Output voltage of the DC power source 1 is high voltage of equal to or higher than 30 [V], and in this case, the output voltage is 350 [V], for example. The DC power source 1 supplies the electrical power to the heater 30 via a supply line 5 and is connected to a ground 9.

The heater 30 is a sheathed heater that generates heat when the electrical power is supplied. The heater 30 is accommodated in the hot water tank 31.

As the IGBT 10 and the IGBT 20 are switched on and off according to an instruction from a controller 3 at an upper level, supply and interruption of the electrical power from the DC power source 1 to the heater 30 are switched. The IGBT 10 and the IGBT 20 are switched on and off by a PWM (Pulse Width Modulation) control. In this embodiment, the IGBT 10 corresponds to a first switching element, and the IGBT 20 corresponds to a second switching element.

The IGBT 10 and the IGBT 20 are periodically switched on and off at periodic cycles different from each other. The IGBT 10 or the IGBT 20 may not be switched periodically, and the on state may be maintained after switched on.

The IGBT 10 is provided upstream of the heater 30, and the IGBT 20 is provided downstream of the heater 30. Because the IGBT 10 and the IGBT 20 are provided in series, the electrical power is supplied from the DC power source 1 to the heater 30 only when both of the IGBT 10 and the IGBT 20 are switched on.

The IGBT 10 is provided with a driver circuit 11 with which the IGBT 10 is switched on and off via a control line 12 and a failure diagnosis circuit 13 that diagnoses whether or not the IGBT 10 is operated normally.

The controller 3 is an ECU (Electronic Control Unit) that controls, for example, the vehicle air-conditioning device. The controller 3 is provided with a CPU (Central Processing Unit) that executes a control of the vehicle air-conditioning device, a ROM (Read-Only Memory) that stores control programs, set values, and so forth required for the processing operation executed by the CPU, and a RAM (Random-Access Memory) that temporarily stores information detected by various sensors. The controller 3 is connected with a heater switch 4 that starts application of the current to the heater 30 when the heater switch 4 is switched on.

In a case in which the vehicle air-conditioning device is of a manually operated type, the heater switch 4 is switched on and off on the basis of operation of a driver. In a case in which the vehicle air-conditioning device is of a automatically operated type, the heater switch 4 is switched on and off on the basis of a cabin heating request from the vehicle air-conditioning device.

With the driver circuit 11, the IGBT 10 is switched on and off on the basis of the instruction from the controller 3. The driver circuit 11 is a gate drive circuit with which a gate of the IGBT 10 is switched on and off.

The failure diagnosis circuit 13 monitors a voltage Va [V] of the electrical power supplied from a DC power source 2A and a voltage of the electrical power supplied from the control line 12, and thereby, diagnoses whether or not the IGBT 10 is operated normally.

The DC power source 2A is connected to the supply line 5 via a diode 14 and is grounded to a ground 19 via the IGBT 10. Therefore, when the IGBT 10 is in an energized state, because the current flows from the DC power source 2A to the ground 19, the voltage Va detected by the failure diagnosis circuit 13 is low (for example, 0 [V]). On the other hand, when the IGBT 10 is in an interrupted state, because the DC power source 2A is insulated against the ground 19, the voltage Va detected by the failure diagnosis circuit 13 is high. The DC power source 2A is of low voltage such that an electric potential difference from the DC power source 2A to the ground 19 is, for example, about 20 [V].

Thus, in a case in which the IGBT 10 is operated normally, an wave form of the voltage Va of the electrical power supplied from the DC power source 2A via the diode 14 and the wave form of a gate signal (gate voltage) supplied from the control line 12 are changed so as to be opposite phases to each other. On the other hand, in a case in which an abnormality is caused in the IGBT 10, and for example, the energized state is constantly continued even if the gate signal is off, regardless of the wave form of the gate signal supplied from the control line 12, the voltage Va of the DC power source 2A is constantly low. Conversely, in a case in which the interrupted state is constantly continued even if the gate signal is on, regardless of the wave form of the gate signal supplied from the control line 12, the voltage Va of the DC power source 2A is constantly high. The failure diagnosis circuit 13 detects such changes of the voltage and diagnoses whether or not the IGBT 10 is operated normally.

Similarly, the IGBT 20 is provided with a driver circuit 21 with which the IGBT 20 is switched on and off via a control line 22 and a failure diagnosis circuit 23 that diagnoses whether or not the IGBT 20 is operated normally. The configurations of the driver circuit 21 and the failure diagnosis circuit 23 are similar to those of the driver circuit 11 and the failure diagnosis circuit 13 described above, and descriptions of the specific configurations thereof shall be omitted.

A DC power source 2B is in a separate system from that of the DC power source 2A, and a ground 29 is in a separate system from that of the ground 19. Thus, the failure diagnosis circuit 13 and the failure diagnosis circuit 23 separately diagnose whether or not the IGBT 10 and the IGBT 20 are operated normally, respectively.

The operation of the heating device 100 will be described below with reference to FIGS. 2 to 5. Routine processes shown in FIGS. 2 and 4 are executed by the controller 3.

The operation of the heating device 100 when the heater switch 4 is switched on will be first described with reference to FIGS. 2 and 3. A description will now be given of a case in which the heating device 100 is in an operation state (a first operation state) where the IGBT 10 has a switching function that allows application of the current to the heater 30 and the IGBT 20 has a control function that performs a frequency control of the heater 30.

In step S11 shown in FIG. 2, it is judged whether or not the heater switch 4 is switched from off to on. When it is judged that the heater switch 4 is switched from off to on in step S11, the process proceeds to step S12. On the other hand, when it is judged that the heater switch 4 is not switched from off to on in step S11, there is no need to supply the electrical power to the heater 30, and the process proceeds to RETURN.

In step S12, it is determined whether or not both of the IGBT 10 and the IGBT 20 are off. When it is judged that both of the IGBT 10 and the IGBT 20 are off in step S12, because the IGBT 10 and the IGBT 20 are in a normal state, the process proceeds to step S13. On the other hand, when it is judged that the IGBT 10 or the IGBT 20 is on in step S12, because the IGBT 10 or the IGBT 20 is in an abnormal state, the process proceeds to step S16 to issue an abnormality alert to the controller 3, and the process proceeds to RETURN.

As described above, if the IGBT 10 or the IGBT 20 is on at the time when the heater switch 4 is switched from off to on, the IGBT 10 or the IGBT 20 is in the abnormal state. Thus, the IGBT 10 and the IGBT 20 are switched on only if both of the IGBT 10 and the IGBT 20 are off when the heater switch 4 is switched from off to on.

In step S13, the IGBT 10 is switched on. As shown in FIG. 3, with the heating device 100, after the heater switch 4 is switched from off to on, the IGBT 10 is switched on with a delay of time T1 [s]. At this time, because the IGBT 20 is kept off, the electrical power from the DC power source 1 is not supplied to the heater 30. As described above, the IGBT 10 is switched on before the IGBT 20.

With the heating device 100, when the IGBT 10 is switched on, the on state is maintained until the heater switch 4 is switched off. As described above, a longer application time of current is set for the IGBT 10 as compared with the IGBT 20.

In step S14 shown in FIG. 2, it is judged whether or not time T2 [s] shown in FIG. 3 has passed. When it is judged that the time T2 has passed in step S14, the process proceeds to step S15. On the other hand, when it is judged that the time T2 has not passed in step S14, the process of step S14 is repeated until the time T2 is passed.

In step S15, PWM control of the IGBT 20 is started. As described above, a timing at which the IGBT 20 is switched on is different from that of the IGBT 10. When the PWM control of the IGBT 20 is started, supply of the electrical power from the DC power source 1 to the heater 30 is started.

When the PWM control of the IGBT 20 is started, as shown in FIG. 3, the heater 30 is switched off for time T4 [s], after it has been switched on for time T3 [s]. As described above, the IGBT 20 is driven under the PWM control in which T3+T4 is set as one periodic cycle.

As described above, the IGBT 10 is kept at the on state while switching operation between on and off of the IGBT 20 is repeated. In addition, the switching operation of the IGBT 20 is executed at least twice while the switching operation of the IGBT 10, in which the IGBT 10 is switched off after switched on, is executed once.

At the time when the IGBT 10 to be switched on first is switched on, the IGBT 20 is off, and so, the electrical power is not supplied to the heater 30. Thus, the current does not flow through the supply line 5 even when the IGBT 10 is switched on, the IGBT 10 to be switched on first is prevented from becoming the abnormal state.

Next, an operation of the heating device 100 when the heater switch 4 is switched off will be described with reference to FIGS. 4 and 5.

In step S21 shown in FIG. 4, it is judged whether or not the heater switch 4 is switched from on to off. When it is judged that the heater switch 4 is switched from on to off in step S21, the process proceeds to step S22. On the other hand, when it is judged that the heater switch 4 is not switched from on to off in step S21, because there is no need to interrupt supply of the electrical power to the heater 30, the process proceeds to RETURN directly.

In step S22, the IGBT 20 is switched off. In contrast to a case in which the heater switch 4 is switched from off to on, as shown in FIG. 5, the IGBT 20 is switched off at the same time as the heater switch 4 is switched from on to off. By doing so, although the IGBT 10 is kept on, the electrical power from the DC power source 1 is not supplied to the heater 30.

In step S23 shown in FIG. 4, it is judged whether or not time T9 [s] shown in FIG. 5 has passed. When it is judged that the time T9 has passed in step S23, the process proceeds to step S24. On the other hand, when it is judged that the time T9 has not passed in step S23, the process of step S23 is repeated until the time T9 is passed.

In step S24, the IGBT 10 is switched off. As described above, the IGBT 10 is switched off after the IGBT 20.

At the time when the IGBT 20 is switched off, although the IGBT 10 is on, supply of the electrical power to the heater 30 is stopped. Thus, because the current is not flowing when the IGBT 10 is switched off, it is possible to prevent the IGBT 10 to be switched off later from becoming the abnormal state.

As described above, because the IGBT 10 having the switching function that allows application of the current to the heater 30 is switched on and off when the current is not flowing through the supply line 5, the abnormal state tends not to be caused in the IGBT 10 as compared with the IGBT 20 having the control function that performs the frequency control of the heater 30. Therefore, even if the abnormal state is caused in the IGBT 20, the IGBT 10 can stop the application of the current to the heater 30 with high reliability.

According to the first embodiment described above, the advantages described below are afforded.

In the heating device 100, the IGBT 10 is kept at the on state while the switching operation between on and off of the IGBT 20 is repeated. In addition, with the heating device 100, the timings of switching on are different for the IGBT 10 and the IGBT 20 that switch supply and interruption of the electrical power for the heater 30, and a longer application time of current is set for the IGBT 10 as compared with the IGBT 20. Therefore, because the IGBT 20 is off at the time when the IGBT 10 is switched on, the electrical power is not supplied to the heater 30. Thus, the current does not flow even if the IGBT 10 is switched on, and so, the IGBT 10 is prevented from becoming an abnormal state. Therefore, it is possible to prevent abnormalities from being caused in the IGBT 10 and the IGBT 20 simultaneously.

It is possible to switch the operation state of the heating device 100 to an operation state (a second operation state) in which the IGBT 10 has the control function that performs the frequency control of the heater 30, and the IGBT 20 has the switching function that allows application of the current to the heater 30.

For example, the first operation state and the second operation state may be alternately switched every time a number of times one of the IGBT 10 and the IGBT 20 having the control function is switched on and off reaches a set number of times. In addition, the first operation state and the second operation state may be alternately switched every time a temperature of one of the IGBT 10 and the IGBT 20 having the control function reaches a set temperature.

By alternately switching the first operation state and the second operation state as described above, it is possible to equalize the number of switching times and the temperature increase of the IGBT 10 and the IGBT 20, and so, it is possible to use the IGBT 10 and the IGBT 20 under the normal state for a longer period.

### Second Embodiment

A heating device 200 according to a second embodiment of the present invention will be described below with main reference to FIGS. 6 and 7. In the following, differences from the above-described embodiment will be mainly described, and components that have similar functions are assigned the same reference numerals and descriptions thereof will be omitted.

The second embodiment differs from the first embodiment in that the heating device 200 has a function of determining, during the heating device 200 is operated, whether or not the IGBT 10 having the switching function that allows application of the current to the heater 30 is operated normally. The operation determination of the IGBT 10 may be executed periodically, or it may be executed at an arbitrary timing.

Because the configuration of the heating device 200 is similar to that of the heating device 100 (see FIG. 1), the description thereof will be omitted here. In addition, because the operations of the heating device 200 when the heater switch 4 is switched on and when the heater switch 4 is switched off are also similar to those of the heating device 100 (see FIGS. 2 to 5), the description thereof will be omitted here.

Also in this embodiment, a description will be given of a case in which the heating device 100 is in the operation state (the first operation state) where the IGBT 10 has the switching function that allows application of the current to the heater 30, and the IGBT 20 has the control function that performs the frequency control of the heater 30.

In step S31 shown in FIG. 6, it is judged whether or not the operation determination of the IGBT 10 is requested by the controller 3. When it is judged that the operation determination of the IGBT 10 is requested in step S31, the process proceeds to step S32. On the other hand, when it is judged that the operation determination of the IGBT 10 is not requested in step S31, the process proceeds to step S38, and the PWM control of the IGBT 20 is continued.

In step S32, it is judged whether or not the IGBT 20 is switched from on to off. When it is judged that the IGBT 20 is switched from on to off in step S32, although the IGBT 10 is kept on, the electrical power from the DC power source 1 is not supplied to the heater 30. Thus, because it is a state capable of performing the operation determination of the IGBT 10, the process proceeds to step S33. On the other hand, when it is judged that the IGBT 20 is not switched from on to off, the process proceeds to step S38, and the PWM control of the IGBT 20 is continued.

In step S33, it is judged whether or not time T6 [s] shown in FIG. 7 has passed. When it is judged that the time T6 has passed in step S33, the process proceeds to step S34. On the other hand, when it is judged that the time T6 has not passed in step S33, the process of step S33 is repeated until the time T6 is passed.

In step S34, the IGBT 10 is switched off. Next, in step S35, it is judged whether or not time T7 [s] shown in FIG. 7 has passed. When it is judged that the time T7 has passed in step S35, the process proceeds to step S36. On the other hand, when it is judged that the time T7 has not passed in step S35, the process of step S35 is repeated until the time T7 is passed. As shown in FIG. 7, the IGBT 10 is driven under the PWM control in which T5+T7 is set as one periodic cycle.

Until the time T7 is passed since the IGBT 10 is switched off in step S34 and in step S35, the failure diagnosis circuit 13 diagnoses whether or not the IGBT 10 is switched off when the gate is switched off. By doing so, it is possible to diagnoses whether or not the IGBT 10 is operated normally.

Until the IGBT 10 is switched on again after it has been switched off, because the IGBT 20 is off, supply of the electrical power to the heater 30 is stopped. Thus, because the current is not flowing when the IGBT 10 is switched, it is possible to prevent the IGBT 10 from becoming the abnormal state at the time of the operation determination.

In step S36, the IGBT 10 is switched on. Next, it is judged whether or not time T8 [s] shown FIG. 7 has passed in step S37. When it is judged that the time T7 has passed in step S37, the process proceeds to step S38, and the PWM control of the IGBT 20 is continued. On the other hand, when it is judged that the time T8 has not passed in step S37, the process step S37 is repeated until the time T8 is passed.

As described above, the time T4 (see FIG. 3) during which the IGBT 20 is switched off during the PWM control is divided into the time T6, the time T7, and the time T8, and the IGBT 20 is switched off only for the time T7. In other words, the IGBT 10 is switched off and is switched on again during the IGBT 20 is switched off.

According to the second embodiment described above, because the IGBT 20 is off until the IGBT 10 is switched on again after it has been switched off in order to determine whether or not the IGBT 10 is operated normally, supply of the electrical power to the heater 30 is stopped. Thus, because the current is not flowing when the IGBT 10 is switched, it is possible to prevent the IGBT 10 from becoming the abnormal state at time of the operation determination.

Embodiments of this invention were described above, but the above embodiments are merely examples of applications of this invention, and the technical scope of this invention is not limited to the specific constitutions of the above embodiments.

This application claims priority based on Japanese Patent Application No. 2015-172917 filed with the Japan Patent Office on Sep. 2, 2015 and Japanese Patent Application No. 2016-133200 filed with the Japan Patent Office on Jul. 5, 2016, the entire contents of which are incorporated into this specification.

1-8. (canceled)

9. A heating device comprising:
a heater configured to generate heat when electrical power is supplied; and
at least two switching elements connected to the heater in series, the switching elements being configured to switch supply and interruption of electrical power for the heater by being switched on and off, wherein
a first switching element of the at least two switching elements is kept at on state while switching operation of a second switching element is repeated between on and off, and
the first switching element is switched from on to off and switched on again while the second switching element is switched off.

10. The heating device according to claim 9, wherein
an application time of current to the first switching element is set longer than that of the second switching element.

11. The heating device according to claim 9, wherein
the switching operation of the second switching element is executed at least twice while a switching operation of the first switching element, in which the first switching element is switched off after switched on, is executed once.

12. The heating device according to claim 9, wherein
the first switching element is switched on before the second switching element and is switched off after the second switching element.

13. The heating device according claim 9, wherein
the first switching element and the second switching element are periodically switched on and off at periodic cycle different from each other.

14. The heating device according claim 9, further comprising
a heater switch configured such that application of current to the heater is started when switched on, wherein
the first switching element and the second switching element are switched on only when both of the first switching element and the second switching element are off when the heater switch is switched on.

15. The heating device according to claim 9, wherein
a first operation state and a second operation state are switched, the first operation state being an operation state in which the first switching element has a switching function that allows application of current to the heater, and the second switching element has a control function that performs frequency control of the heater,
the second operation state being an operation state in which the first switching element has a control function that performs frequency control of the heater, and the second switching element has a switching function that allows application of current to the heater.
